(19) United States
(12) Patent Application Publication
(10) Pub. No.: US 2025/0187981 A1
(43) Pub. Date: Jun. 12, 2025

(54) Low-Strength Cementitious Composition and Process for Ponded and Landfilled Coal Ash

(71) Applicant: University of Kentucky Research Foundation, Lexington, KY (US)

(72) Inventor: Robert Benjamin Jewell, Lexington, KY (US)

(21) Appl. No.: 18/971,638

(22) Filed: Dec. 6, 2024

Related U.S. Application Data
(60) Provisional application No. 63/606,729, filed on Dec. 6, 2023.

(51) Int. Cl. C04B 28/04; C04B 18/06; C04B 18/08; C04B 18/10; C04B 20/04

(52) U.S. Cl. CPC C04B 28/04; C04B 18/061; C04B 18/08; C04B 18/105; C04B 20/04

(57) ABSTRACT

A controlled low-strength material includes unprocessed coal ash including any unburned carbon and organic debris, fluidized bed combustion bottom ash, ordinary portland cement, and water. The controlled low-strength material is made by mixing together the unprocessed coal ash including any unburned carbon and organic debris, the fluidized bed combustion bottom ash, the ordinary portland cement, and the water.

### RELATED APPLICATIONS

This document claims the benefit of U.S. Provisional Patent Application Ser. No. 63/606,729, filed on Dec. 6, 2023, the full disclosure of which is incorporated herein by reference.

### TECHNICAL FIELD

This document relates to a new and improved controlled low-strength material as well as to a new and improved method of producing a controlled low-strength material.

### BACKGROUND

A controlled low-strength material (CLSM), also known as a flowable fill, is a self-consolidating, cementitious material that is primarily used as a backfill and may be used as an alternative to compacted fill. CLSM has a compressive strength of 1200 psi (8.3 MPa) or less. It may be used for any application that needs some strength but is not so strong to prevent the material from being excavated at a later time. It has superior flow characteristics when compared to ordinary concrete and may be used, for example, to backfill abutments and retaining walls, storm water concrete pipe, sewer pipe and the like.

### SUMMARY

In accordance with the purposes and benefits set forth herein, a controlled low-strength material (CLSM), comprising, consists of or consists essentially of unprocessed coal ash including unburned carbon and organic debris, fluidized bed combustion bottom ash, ordinary portland cement and water.

In at least one embodiment, the controlled low-strength material includes 50-90 weight percent unprocessed coal ash, 5-30 weight percent fluidized bed combustion bottom ash, 5-35 weight percent ordinary portland cement, and 28.7-42.0 weight percent water. In another possible embodiment, the controlled low-strength material includes 79-81 weight percent unprocessed coal ash, 14-16 weight percent fluidized bed combustion bottom ash, 5-7 weight percent ordinary portland cement, and 28-42 weight percent water.

In at least some embodiments, about 90% of the unprocessed coal ash passes through a 16-mesh sieve with a remaining 10% passing through a 12-mesh sieve. In at least some embodiments, 100% of the unprocessed coal ash passes through a 16-mesh sieve.

In some of the many possible embodiments, the weight ratio of unprocessed coal ash to fluidized bed combustion bottom ash is about 5.33. In some embodiments, the weight ratio of fluidized bed combustion bottom ash to ordinary portland cement is about 3.00. In some embodiments, the weight ratio of a sum of the unprocessed coal ash and the fluidized combustion bottom ash to the ordinary portland cement is about 19.00.

In at least some embodiments, the ordinary portland cement is Type I or Type IL. The unprocessed coal ash including, unburned carbon and organic debris includes ponded coal ash and/or landfilled coal ash.

In accordance with an additional aspect, a method of producing a controlled low-strength material (CLSM), comprises, consists of or consists essentially of mixing together unprocessed coal ash including unburned carbon and organic debris, fluidized bed combustion bottom ash, ordinary portland cement, and water.

The method may further include further drying the unprocessed coal ash, including unburned carbon and organic debris, to obtain a dried unprocessed coal ash, including unburned carbon and organic debris, prior to mixing.

The method may further include passing the dried unprocessed coal ash, including unburned carbon and organic debris, through a 16-mesh sieve prior to the mixing. Still further, the method may include milling the dried unprocessed coal ash, including unburned carbon and organic debris, until the dried unprocessed coal ash, including unburned carbon and organic debris, passes through a 16-mesh sieve.

In the following description, there are shown and described several different embodiments of the new and improved controlled low-strength material and the related method of producing the same. As it should be realized, the material and method are capable of other, different embodiments and their several details are capable of modification in various, obvious aspects all without departing from the device as set forth and described in the following claims. Accordingly, the descriptions should be regarded as illustrative in nature and not as restrictive.

### DETAILED DESCRIPTION

A controlled low-strength material (CLSM) or low-strength cementitious grout, comprises, consists of or consists essentially of unprocessed coal ash including any unburned carbon and organic debris in the coal ash, fluidized bed combustion bottom ash, ordinary portland cement and water. Thus, the technology takes an as received (AR) coal ash from a land fill or a pond including any unburned carbon and organic material (e.g. sticks and plant roots) thereby greatly reducing any processing costs.

The controlled low-strength material of claim 1, may comprise about 50-90 weight percent unprocessed coal ash, about 5-30 weight percent fluidized bed combustion bottom ash, about 5-35 weight percent ordinary portland cement, and about 28-42 weight percent water. In one particularly useful embodiment, the controlled low-strength material comprises about 79-81 weight percent unprocessed coal ash, about 14-16 weight percent fluidized bed combustion bottom ash, about 5-7 weight percent ordinary portland cement, and about 37.7-39.7 weight percent water.

The unprocessed coal ash, including unburned carbon and organic debris, is reduced in size to less than about 1.19 mm before being blended or mixed with the other components of the material. In some formulations, about 90% of the unprocessed coal ash passes through a 16-mesh sieve with a remaining about 10% passing through a 12-mesh sieve. In other formulations, 100% of the unprocessed coal ash passes through a 16-mesh sieve.

The fluidized bed combustion bottom ash (aka spent bed) has a high calcium oxide content, of approximately 50.0%, which can aid in creating the cementitious blend with the unprocessed coal ash or ponded/landfilled ash. More specifically, the fluidized bed combustion bottom ash appears to act as an “activator” for strength development. The ordinary portland cement is preferably Type I or Type IL.

The controlled low-strength material may have a weight ratio of unprocessed coal ash to fluidized bed combustion bottom ash of about 5.33. The controlled low-strength material may have a weight ratio of fluidized bed combustion bottom ash to ordinary portland cement of about 3.00. The controlled low-strength material may have a weight ratio of a sum of the unprocessed coal ash and the fluidized combustion bottom ash to the ordinary portland cement of about 19.00.

The controlled low-strength material may be prepared or produced by first drying the unprocessed coal ash, including unburned carbon and organic debris, to obtain a dried unprocessed coal ash, including unburned carbon and organic debris. The drying may, for example, be accomplished by heating in an oven at 60° C. until dry. The dried unprocessed coal ash, including any unburned carbon and organic debris, may then be subjected to sizing by passing through a 16-mesh sieve to obtain a maximum particle size of about 1.19 mm. The larger material may then be milled in a ball mill until it will pass through the 16-mesh sieve.

The sized unprocessed coal ash, including unburned carbon and organic debris, is then mixed together with fluidized bed combustion bottom ash, ordinary portland cement, and water in the indicated amounts or quantities to produce the controlled low-strength material.

### Experimental Example

1,600 g of ponded coal ash, including any unburned carbon and organic debris, 300 g of fluidized bed combustion bottom ash, 100 g of ordinary portland cement Type I or Type IL, and 773.1 g of water were blended together to provide a water to cement ratio of 0.387. the resulting controlled low-strength material achieved 340 psi at fourteen days of curing and 1100 psi at 28 days of curing.

This document may be said to relate to the following items:
1. A controlled low-strength material (CLSM), comprising, consisting or consisting essentially of:
   unprocessed coal ash including any unburned carbon and organic debris;
   fluidized bed combustion bottom ash;
   ordinary portland cement; and
   water.
2. The controlled low-strength material of item 1, including:
   about 50-90 weight percent unprocessed coal ash;
   about 5-30 weight percent fluidized bed combustion bottom ash;
   about 5-35 weight percent ordinary portland cement; and
   about 28-42 weight percent water.
3. The controlled low-strength material of item 1, including:
   about 79-81 weight percent unprocessed coal ash;
   about 14-16 weight percent fluidized bed combustion bottom ash;
   about 5-7 weight percent ordinary portland cement; and
   about 37.7-39.7 weight percent water.
4. The controlled low-strength material of item 1, wherein about 90% of the unprocessed coal ash passes through a 16-mesh sieve with a remaining about 10% passing through a 12-mesh sieve.
5. The controlled low-strength material of item 1, wherein 100% of the unprocessed coal ash passes through a 16-mesh sieve.
6. The controlled low-strength material of item 1, wherein the weight ratio of unprocessed coal ash to fluidized bed combustion bottom ash is about 5.33.
7. The controlled low-strength material of item 1, wherein the weight ratio of fluidized bed combustion bottom ash to ordinary portland cement is about 3.00.
8. The controlled low-strength material of item 1, wherein the weight ratio of a sum of the unprocessed coal ash and the fluidized combustion bottom ash to the ordinary portland cement is about 19.00.
9. The controlled low-strength material of item 2, wherein about 90% of the unprocessed coal ash passes through a 16-mesh sieve with a remaining about 10% passing through a 12-mesh sieve.
10. The controlled low-strength material of item 2, wherein 100% of the unprocessed coal ash passes through a 16-mesh sieve.
11. The controlled low-strength material of item 3, wherein about 90% of the unprocessed coal ash passes through a 16-mesh sieve with a remaining about 10% passing through a 12-mesh sieve.
12. The controlled low-strength material of item 3, wherein 100% of the unprocessed coal ash passes through a 16-mesh sieve.
13. The controlled low-strength material of item 1, wherein the ordinary portland cement is Type I or Type IL.
14. The controlled low-strength material of item 2, wherein the ordinary portland cement is Type I or Type IL.
15. The controlled low-strength material of item 1, wherein the unprocessed coal ash, including any unburned carbon and organic debris, is landfilled ash.
16. The controlled low-strength material of item 1, wherein the unprocessed coal ash, including any unburned carbon and organic debris, is ponded ash.
17. A method of producing a controlled low-strength material (CLSM), comprising:
   mixing together unprocessed coal ash including any unburned carbon and organic debris, fluidized bed combustion bottom ash, ordinary portland cement, and water.
18. The method of item 17, further including drying the unprocessed coal ash, including any unburned carbon and organic debris, to obtain a dried unprocessed coal ash, including unburned carbon and organic debris, prior to mixing.
19. The method of item 18, further including passing the dried unprocessed coal ash, including any unburned carbon and organic debris, through a 16-mesh sieve prior to the mixing.
20. The method of item 19, further including milling the dried unprocessed coal ash, including any unburned carbon and organic debris, until the dried unprocessed coal ash, including unburned carbon and organic debris, passes through a 16-mesh sieve.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a ball mill”, as used herein, may also refer to, and encompass, a plurality of ball mills.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to +10% of the stated numerical value.

Although the controlled low-strength material and method of making such a controlled low-strength material set forth in this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A controlled low-strength material (CLSM), comprising:
unprocessed coal ash including any unburned carbon and organic debris;
fluidized bed combustion bottom ash;
ordinary portland cement; and
water.

2. The controlled low-strength material of claim 1, including:
about 50-90 weight percent unprocessed coal ash;
about 5-30 weight percent fluidized bed combustion bottom ash;
about 5-35 weight percent ordinary portland cement; and
about 28-42 weight percent water.

3. The controlled low-strength material of claim 1, including:
about 79-81 weight percent unprocessed coal ash;
about 14-16 weight percent fluidized bed combustion bottom ash;
about 5-7 weight percent ordinary portland cement; and
about 37.7-39.7 weight percent water.

4. The controlled low-strength material of claim 1, wherein about 90% of the unprocessed coal ash passes through a 16-mesh sieve with a remaining about 10% passing through a 12-mesh sieve.

5. The controlled low-strength material of claim 1, wherein 100% of the unprocessed coal ash passes through a 16-mesh sieve.

6. The controlled low-strength material of claim 1, wherein the weight ratio of unprocessed coal ash to fluidized bed combustion bottom ash is about 5.33.

7. The controlled low-strength material of claim 1, wherein the weight ratio of fluidized bed combustion bottom ash to ordinary portland cement is about 3.00.

8. The controlled low-strength material of claim 1, wherein the weight ratio of a sum of the unprocessed coal ash and the fluidized combustion bottom ash to the ordinary portland cement is about 19.00.

9. The controlled low-strength material of claim 2, wherein about 90% of the unprocessed coal ash passes through a 16-mesh sieve with a remaining about 10% passing through a 12-mesh sieve.

10. The controlled low-strength material of claim 2, wherein 100% of the unprocessed coal ash passes through a 16-mesh sieve.

11. The controlled low-strength material of claim 3, wherein about 90% of the unprocessed coal ash passes through a 16-mesh sieve with a remaining about 10% passing through a 12-mesh sieve.

12. The controlled low-strength material of claim 3, wherein 100% of the unprocessed coal ash passes through a 16-mesh sieve.

13. The controlled low-strength material of claim 1, wherein the ordinary portland cement is Type I or Type IL.

14. The controlled low-strength material of claim 2, wherein the ordinary portland cement is Type I or Type IL.

15. The controlled low-strength material of claim 1, wherein the unprocessed coal ash, including any unburned carbon and organic debris, is landfilled ash.

16. The controlled low-strength material of claim 1, wherein the unprocessed coal ash, including any unburned carbon and organic debris, is ponded ash.

17. A method of producing a controlled low-strength material (CLSM), comprising:
mixing together unprocessed coal ash including any unburned carbon and organic debris, fluidized bed combustion bottom ash, ordinary portland cement, and water.

18. The method of claim 17, further including drying the unprocessed coal ash, including any unburned carbon and organic debris, to obtain a dried unprocessed coal ash, including unburned carbon and organic debris, prior to mixing.

19. The method of claim 18, further including passing the dried unprocessed coal ash, including any unburned carbon and organic debris, through a 16-mesh sieve prior to the mixing.

20. The method of claim 19, further including milling the dried unprocessed coal ash, including any unburned carbon and organic debris, until the dried unprocessed coal ash, including unburned carbon and organic debris, passes through a 16-mesh sieve.
